(19) United States
(12) Patent Application Publication
(10) Pub. No.: US 2020/0213522 A1
(43) Pub. Date: Jul. 2, 2020

(54) ACTUATOR AND CAMERA DEVICE

(71) Applicant: Panasonic Intellectual Property Management Co., Ltd., Osaka (JP)

(72) Inventors: Masaaki OCHI, Osaka (JP); Hironori TOMITA, Nara (JP)

(21) Appl. No.: 16/631,768

(22) PCT Filed: Jul. 13, 2018
(86) PCT No.: PCT/JP2018/026476

§ 371 Date: Jan. 16, 2020

(30) Foreign Application Priority Data
Jul. 18, 2017 (JP) 2017-139503

(51) Int. Cl. H04N 5/232; H04N 5/225; H02K 11/215; H02K 41/06

(52) U.S. Cl. CPC H04N 5/23299; H04N 5/2253; H02K 41/06; H02K 11/215; H04N 5/23258

(57) ABSTRACT

An actuator includes a first module, a second module, and a mounting unit. The second module supports the first module to make the first module rotatable around each of an X-axis and a Y-axis. The mounting unit supports the second module to make the second module rotatable. The second module has a movable range of 360 degrees or more with respect to the mounting unit. The second module includes a panning drive coil, a tilting drive coil, and a second rolling drive coil.

### TECHNICAL FIELD

The present disclosure relates to an actuator and a camera device, and more particularly relates to an actuator and camera device configured to drive an object to be driven in rotation.

### BACKGROUND ART

A camera driver (actuator) has been known in the art as a device for rotating a camera unit as an object to be driven in three axis directions that are perpendicular to each other (see, for example, Patent Literature 1).

According to Patent Literature 1, however, the movable range is limited in each of the three axis directions. For example, the movable range is from −15 degrees to +15 degrees in panning and tilting directions, and is about 5 degrees in a rolling direction.

To expand the movable range of the camera unit, an external device such as a motor needs to be provided for the camera driver (actuator), thus sometimes requiring complex wiring to connect the external device to the camera driver.

### CITATION LIST

### Patent Literature

Patent Literature 1: WO 2010/010712 A1

### SUMMARY OF INVENTION

In view of the foregoing background, it is therefore an object of the present disclosure to provide an actuator and camera device with the ability to expand the movable range while simplifying the wiring scheme.

An actuator according to an aspect of the present disclosure includes a first module, a second module, and a mounting unit. The first module includes a first magnet and a second magnet. The second module supports the first module to make the first module rotatable around each of a first axis and a second axis perpendicular to the first axis. The mounting unit includes a third magnet and supports the second module to make the second module rotatable. The second module has a movable range of 360 degrees or more with respect to the mounting unit. The second module includes a first coil, a second coil, and a third coil. The first coil electromagnetically drives the first module in rotation around the first axis with respect to the second module by generating magnetic force between the first coil itself and the first magnet. The second coil electromagnetically drives the first module in rotation around the second axis with respect to the second module by generating magnetic force between the second coil itself and the second magnet. The third coil electromagnetically drives the mounting unit in rotation with respect to the second module by generating magnetic force between the third coil itself and the third magnet.

A camera device according to another aspect of the present disclosure includes the actuator described above, and a camera module arranged in the first module.

An actuator according to still another aspect of the present disclosure includes a first module, a second module, a first driving unit, a second driving unit, a mounting unit, and a third driving unit. The first module is rotatable around each of a first axis and a second axis perpendicular to the first axis. The second module supports the first module to make the first module rotatable around the first axis and the second axis. The first driving unit includes a first coil and a first magnet and electromagnetically drives the first module in rotation around the first axis with respect to the second module. The second driving unit includes a second coil and a second magnet and electromagnetically drives the first module in rotation around the second axis with respect to the second module. The mounting unit is to be fitted to the second module. The third driving unit includes a third coil and a third magnet and electromagnetically drives the second module in rotation around a third axis, which is perpendicular to both of the first axis and the second axis, with respect to the mounting unit with a moving range expanded to 360 degrees or more. The first coil, the second coil, and the third coil are all provided for the second module.

### BRIEF DESCRIPTION OF DRAWINGS

FIG. 1 is a block diagram illustrating a configuration for a camera device according to a first exemplary embodiment of the present disclosure;

FIG. 2A is a perspective view of the camera device;

FIG. 2B is an exploded perspective view of the camera device;

FIG. 2C is a cross-sectional view of the camera device;

FIG. 3A is a perspective view of a subassembly constituted of a camera module, a movable unit, and a fixed unit, which are included in the camera device;

FIG. 3B is a plan view of the subassembly constituted of the camera module, movable unit, and fixed unit included in the camera device;

FIG. 4 is a cross-sectional view, taken along the plane X1-X1, of the subassembly constituted of the camera module, movable unit, and fixed unit included in the camera device;

FIG. 5 is an exploded perspective view of the subassembly constituted of the camera module, movable unit, and fixed unit included in the camera device;

FIG. 6 is an exploded perspective view of the movable unit included in the camera device;

FIG. 7 is a block diagram illustrating a configuration for a camera device according to a second exemplary embodiment of the present disclosure;

FIG. 8A is a perspective view of the camera device;

FIG. 8B is a cross-sectional view of the camera device; and

FIG. 9 is a view illustrating a variation of the camera device.

### DESCRIPTION OF EMBODIMENTS

Note that embodiments and their variations to be described below are only examples of the present disclosure and should not be construed as limiting. Rather, those embodiments and variations may be readily modified in various manners depending on a design choice or any other factor without departing from a true spirit and scope of the present disclosure. The drawings to be referred to in the following description of first and second embodiments are all schematic representations. That is to say, the ratio of the dimensions (including thicknesses) of respective constituent elements illustrated on the drawings does not always reflect their actual dimensional ratio.

### First Embodiment

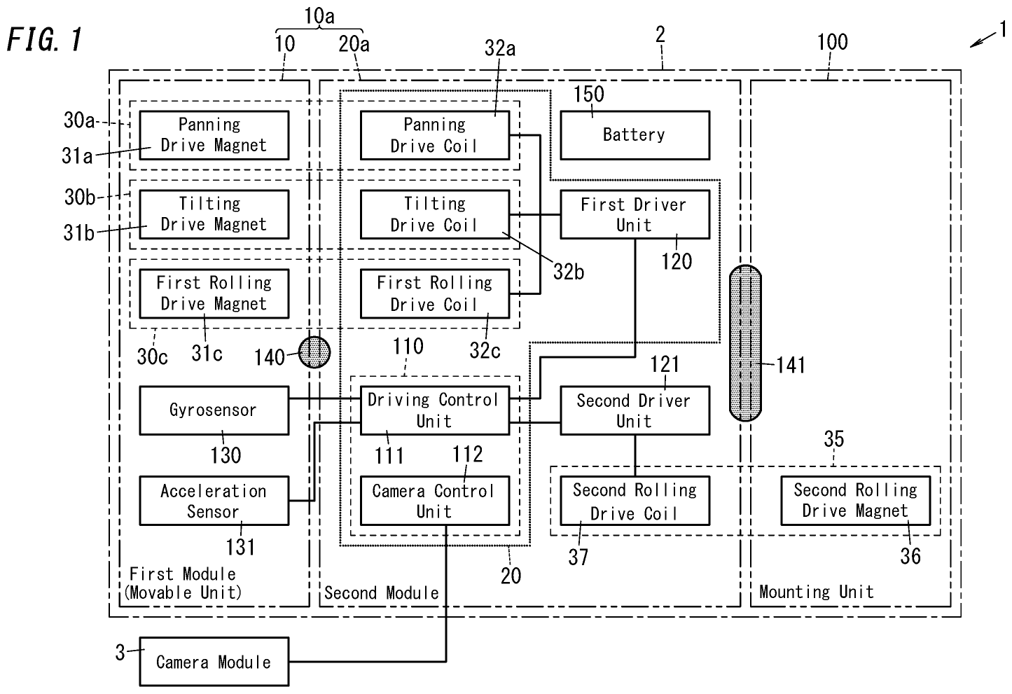

A camera device according to a first exemplary embodiment will be described with reference to FIGS. 1-6.

(1) Overview

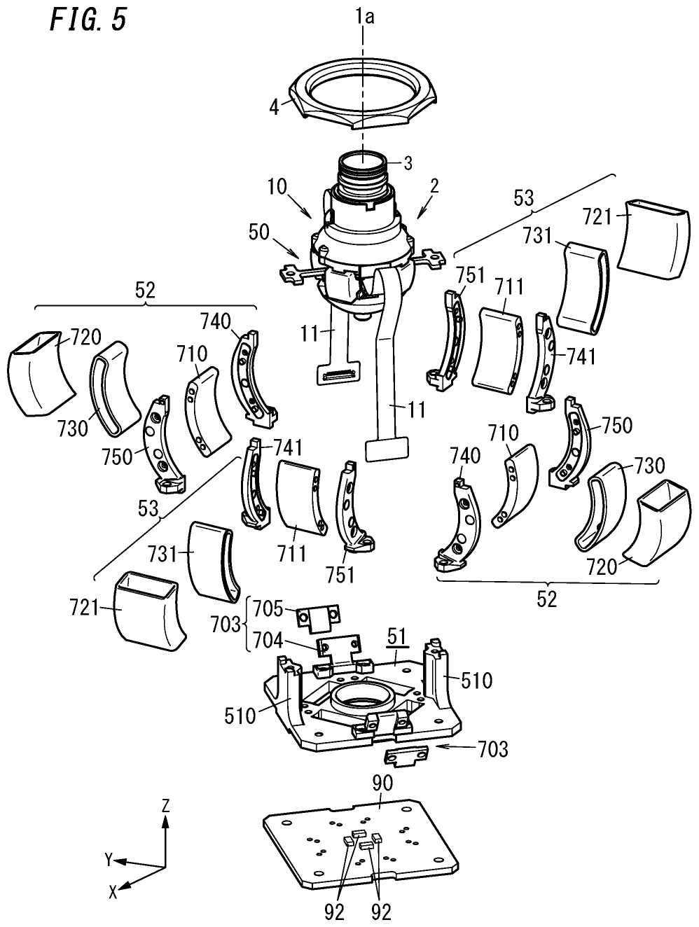

As shown in FIG. 1, the camera device 1 according to this embodiment includes a camera module 3, and a panning driving unit 30a, a tilting driving unit 30b, and a first rolling driving unit 30c for driving a first module (hereinafter also referred to as a “movable unit”) 10 that holds the camera module 3 thereon. The camera device 1 also includes a gyrosensor 130 and acceleration sensor 131 for detecting the movement of the camera device 1. The camera device 1 controls the panning driving unit 30a, the tilting driving unit 30b, and the first rolling driving unit 30c based on the result of detection by the gyrosensor 130, the acceleration sensor 131, and a magnetic sensor 92 (see FIG. 5), for example. This allows the camera device 1 to serve as a camera device with a stabilizer that reduces unnecessary vibrations of the camera module 3.

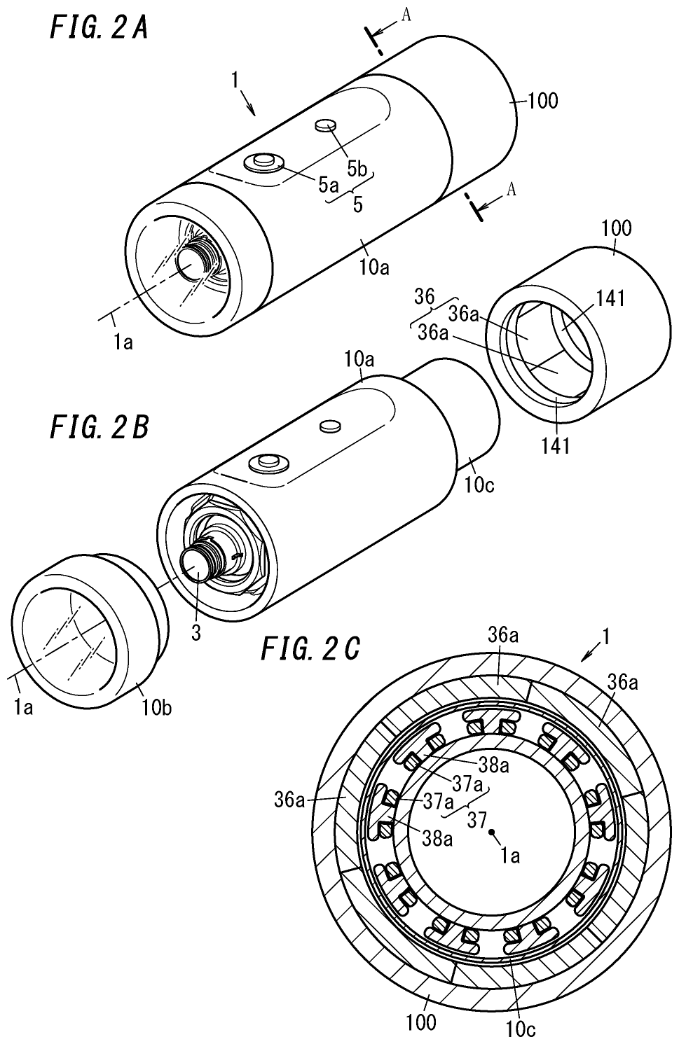

The camera device 1 has a cylindrical shape in appearance (see FIG. 2A), and includes an image capturing unit body 10a with a camera module 3, a first module (movable unit) 10, and a second module 20a, and a mounting unit 100.

In the image capturing unit body 10a, the camera module 3, the movable unit 10, the second module 20a, and the mounting unit 100 are arranged in this order along the optical axis 1a of the camera module 3 (see FIG. 2A). A lens cover 10b is also provided at the tip of the camera module 3 (see FIG. 2B).

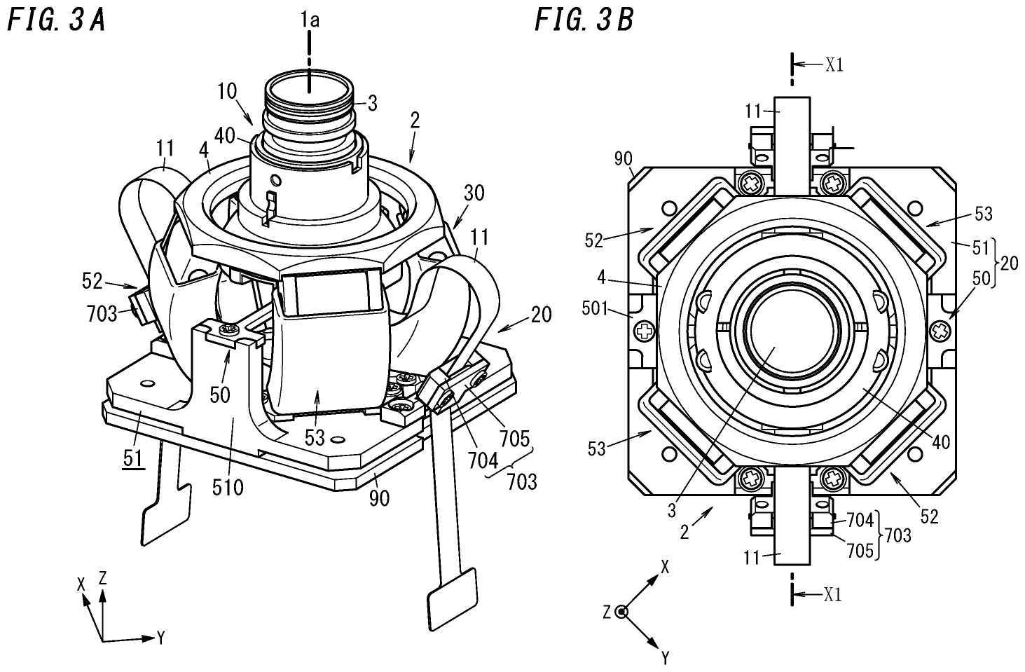

The second module 20a of the image capturing unit body 10a is provided with the movable unit 10 with the camera module 3 at one of two ends of the second module 20a along the optical axis 1a of the camera module 3 (see FIG. 3A). To the second module 20a, the mounting unit 100 is fitted at the other of the two ends along the optical axis 1a of the movable unit 10.

The mounting unit 100 electromagnetically drives the image capturing unit body 10a in rotation around the optical axis 1a of the camera module 3 with respect to the mounting unit 100 itself with the movable range expanded to 360 degrees or more.

The camera device 1 further includes an operating unit 5 with a plurality of operating buttons 5a, 5b (see FIG. 2A). The user is allowed to operate the camera module 3, such as starting or ending shooting, using the operating unit 5.

(2) Configuration

Next, the functional configuration of the camera device 1 according to this embodiment will be described in detail with reference to FIG. 1.

The camera device 1 may be a portable camera, for example, and includes an actuator 2 and the camera module 3. The camera module 3 may be rotated by the actuator 2 in tilting, panning, and rolling directions. The actuator 2 serves as a stabilizer for driving the camera module 3 in any desired rotational direction with unnecessary vibrations of the camera module 3 reduced.

The camera device 1 includes the camera module 3, the panning driving unit 30a, the tilting driving unit 30b and the first rolling driving unit 30c, the gyrosensor 130 and the acceleration sensor 131, and a control unit 110. In this embodiment, the camera device 1 further includes the movable unit 10 for holding the camera module 3 (see FIG. 3A), a fixed unit 20 for supporting the movable unit 10 rotatably (see FIG. 3A), and a second rolling driving unit 35. In the example illustrated in FIG. 1, the camera device 1 further includes a first driver unit 120, a second driver unit 121, and a battery 150. The panning driving unit 30a, the tilting driving unit 30b, the first rolling driving unit 30c, the second rolling driving unit 35, the gyrosensor 130, the acceleration sensor 131, the control unit 110, the first driver unit 120, and the second driver unit 121 together form the actuator 2.

The camera device 1 further includes a first holding mechanism 140 (see FIG. 1). The fixed unit 20 holds the movable unit 10 movably via the first holding mechanism 140. The movable unit 10 and the fixed unit 20 will be described in detail later.

The camera device 1 further includes a second holding mechanism 141 for holding the image capturing unit body 10a so as to make the image capturing unit body 10a rotatable around the optical axis 1a with respect to the mounting unit 100 with the movable range expanded to 360 degree or more (see FIG. 1). The mounting unit 100 holds the image capturing unit body 10a via the second holding mechanism 141 that is rotatable around the optical axis 1a. The second holding mechanism 141 may be implemented as a bearing, for example, and provided for the mounting unit 100. In this embodiment, two second holding mechanisms 141 are arranged side by side along the optical axis 1a on the inner peripheral surface of the mounting unit 100 so as to interpose the second rolling drive magnet 36 (to be described later) that the second rolling driving unit 35 includes (see FIG. 2B). This allows the camera device 1 to hold the image capturing unit body 10a so as to make the image capturing unit body 10a rotatable with respect to the mounting unit 100.

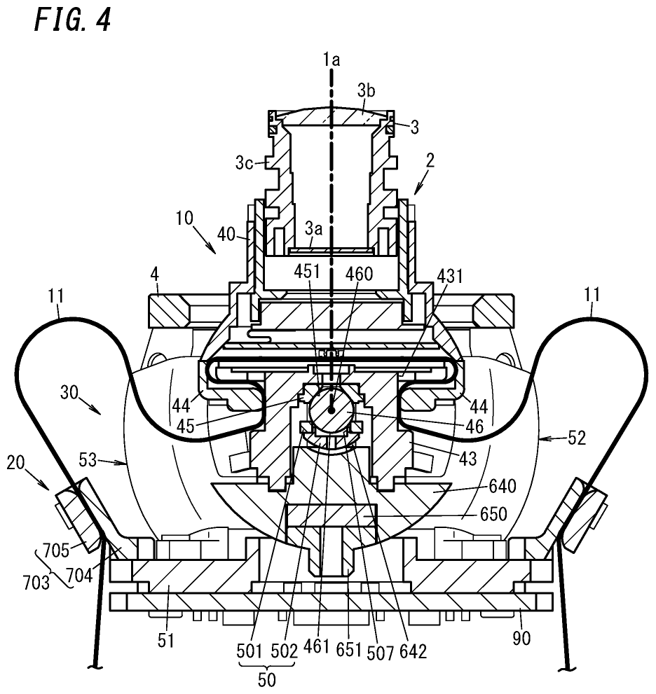

The camera module 3 includes an image sensor 3a (see FIG. 4). The camera module 3 converts video produced on the image capturing plane of the image sensor 3a into a video signal as an electrical signal. Also, a plurality of cables to transmit the electrical signal (video signal) generated by the image sensor 3a to a camera control unit 112 (to be described later) are electrically connected to the camera module 3 via connectors.

The panning driving unit 30a, tilting driving unit 30b, and first rolling driving unit 30c drive the movable unit 10 such that the movable unit 10 moves relative to the fixed unit 20. The panning driving unit 30a, tilting driving unit 30b, and first rolling driving unit 30c are electromagnetic drivers for driving the movable unit 10 by energizing the coils. The movable unit 10 holds the camera module 3. Thus, the driving unit 30 driving the movable unit 10 causes the camera module 3 to move along with the movable unit 10.

In this embodiment, the movable unit 10 (camera module 3) is configured to be movable, relative to the fixed unit 20, in at least two directions selected from the group consisting of a panning direction, a tilting direction, and a rolling direction. The direction of movement of the movable unit 10 rotating around the optical axis 1a of the camera module 3 (see FIG. 3A) will be hereinafter referred to as a “rolling direction.” The direction of movement of the movable unit 10 rotating around an X-axis will be hereinafter referred to as a “panning direction.” The direction of movement of the movable unit 10 rotating around a Y-axis will be hereinafter referred to as a “tilting direction.” The optical axis 1a of the camera module 3 in a state where the movable unit 10 is not driven by the driving unit 30 (i.e., the state shown in FIG. 3A), the X-axis, and the Y-axis are perpendicular to each other.

The panning driving unit 30a includes a panning drive magnet 31a and a panning drive coil 32a. Energizing the panning drive coil 32a causes the movable unit 10 to be driven in the panning direction with the electromagnetic force applied to the panning drive magnet 31a.

The tilting driving unit 30b includes a tilting drive magnet 31b and a tilting drive coil 32b. Energizing the tilting drive coil 32b causes the movable unit 10 to be driven in the tilting direction with the electromagnetic force applied to the tilting drive magnet 31b.

The first rolling driving unit 30c includes a first rolling drive magnet 31c and a first rolling drive coil 32c. Energizing the first rolling drive coil 32c causes the movable unit 10 to be driven in the rolling direction with the electromagnetic force applied to the first rolling drive magnet 31c.

Note that the panning driving unit 30a, the tilting driving unit 30b, and the first rolling driving unit 30c will be described in detail later.

The second rolling driving unit 35 is configured to electromagnetically drive the fixed unit 20 in rotation around the optical axis 1a with respect to the mounting unit 100 with the movable range expanded to 360 degrees or more. The second rolling driving unit 35 may be implemented as, for example, a brushless motor, and includes a second rolling drive magnet 36 and a second rolling drive coil 37. The second rolling drive magnet 36 is provided for the mounting unit 100 and the second rolling drive coil 37 is provided for the second module 20a. Energizing the second rolling drive coil 37 causes the image capturing unit body 10a to be driven in the rolling direction with respect to the mounting unit 100 with the electromagnetic force applied to the second rolling drive magnet 36.

The second rolling driving unit 35 will be described more specifically with reference to FIGS. 2B and 2C. FIG. 2C is a cross-sectional view schematically illustrating a cross section taken along a plane including the line segment A-A and perpendicular to the optical axis 1a. In FIG. 2C, the configuration of the image capturing unit body 10a is simplified for the sake of convenience.

The image capturing unit body 10a includes an end portion 10c extending along the optical axis 1a and having the shape of a cylinder, of which the center axis is defined by the optical axis 1a.

As shown in FIG. 2C, a plurality of coils 37 are provided around the optical axis 1a and along the inner peripheral surface of the end portion 10c. Specifically, the image capturing unit body 10a includes, at the end portion 10c, a plurality of yokes 38a, which are arranged around the optical axis 1a and along the inner peripheral surface of the end portion 10c. The end portion 10c has a very small thickness (see FIG. 2C), which prevents the gap between the second rolling drive coil 37 and the second rolling drive magnet 36 from widening. In addition, the end portion 10c also prevents water from entering from outside of the actuator 2. Winding a conductive wire around each of the plurality of yokes 38a allows the coil 37a to be formed.

In addition, as shown in FIGS. 2B and 2C, a plurality of magnets 36 are provided for the mounting unit 100 so as to be arranged along the circumference of another circle centered around the optical axis 1a and to surround the plurality of coils 37a.

The second rolling drive coil 37 described above is constituted of the plurality of coils 37a. The second rolling drive magnet 36 described above is constituted of the plurality of magnets 36a. In short, the second rolling driving unit 35 according to this embodiment is implemented as a brushless motor of an outer rotor type. Energizing the plurality of coils 37a causes the plurality of magnets 36a to rotate around the optical axis 1a with respect to the plurality of coils 37a with the movable range expanded to 360 degrees or more. In other words, the image capturing unit body 10a rotates relative to the mounting unit 100.

The gyrosensor 130 is provided for the movable unit (first module) 10 to detect (sense) the orientation (i.e., tilt) of the camera device 1. Specifically, the gyrosensor 130 detects the respective angular velocities in the panning, tilting, and rolling directions of the movable unit 10. The gyrosensor 130 outputs the result of detection to a driving control unit 111.

The acceleration sensor 131 is provided for the movable unit (first module) 10 to detect the acceleration applied to the movable unit 10 in the panning, tilting, and rolling directions of the movable unit 10. The acceleration sensor 131 outputs the result of detection to the driving control unit 111.

The control unit 110 includes, as its major constituent element, a microcontroller including a processor and a memory, and performs the functions of the control unit 110 by making its processor execute a program stored in its memory. The program may be stored in advance in the memory. Alternatively, the program may also be downloaded via a telecommunications line such as the Internet or distributed after having been stored on a storage medium such as a memory card.

The control unit 110 performs a function as the driving control unit 111 and a function as a camera control unit 112. The driving control unit 111 drives the movable unit 10 by controlling the panning driving unit 30a, the tilting driving unit 30b, and the first rolling driving unit 30c. In addition, the driving control unit 111 also drives the mounting unit 100 by controlling the second rolling driving unit 35.

The driving control unit 111 controls, based on the results of detection by the gyrosensor 130, the acceleration sensor 131, and the magnetic sensor 92 (see FIG. 5), the panning driving unit 30a, the tilting driving unit 30b, the first rolling driving unit 30c, and the second rolling driving unit 35.

The driving control unit 111 performs, based on the angular velocities detected by the gyrosensor 130, the acceleration detected by the acceleration sensor 131, and the result of detection by the magnetic sensor 92 (to be described later), signal processing for compensating for the shake, caused by the shooter's hand tremors, of the camera module 3. Specifically, the driving control unit 111 calculates the angle of rotation of the camera module 3 based on the respective results of detection by the gyrosensor 130, the acceleration sensor 131, and the magnetic sensor 92.

The driving control unit 111 controls the panning driving unit 30a, the tilting driving unit 30b, the first rolling driving unit 30c, and the second rolling driving unit 35 so that the movable unit 10 faces a certain direction. Specifically, the driving control unit 111 makes the first driver unit 120 control the panning driving unit 30a, the tilting driving unit 30b, and the first rolling driving unit 30c to have the movable unit 10 rotated to the angle of rotation obtained. The driving control unit 111 generates, based on the angle of rotation obtained, a first drive signal for driving the movable unit 10 in the tilting, panning, and rolling directions. The driving control unit 111 outputs the first drive signal to the first driver unit 120. In addition, the driving control unit 111 makes the second driver unit 121 control the second rolling driving unit 35 to have the fixed unit 20 rotated to the angle of rotation obtained with respect to the mounting unit 100. The driving control unit 111 generates a second drive signal for rotating the fixed unit 20 in the rolling direction with respect to the mounting unit 100. Then, the driving control unit 111 outputs the second drive signal to the second driver unit 121.

The first drive signal is a signal generated by the pulse width modulation (PWM) and used to drive the movable unit 10 by changing the duty ratio. The second drive signal is a three-phase AC signal generated by the PWM and used to drive the mounting unit 100 by changing the AC frequency and the amplitude.

The first drive signal and the second drive signal have the capability of controlling vibrations with frequencies of a few Hz to several ten Hz to allow the actuator 2 to serve as a stabilizer.

In the embodiment described above, the gyrosensor 130 is provided for the first module (movable unit) 10. However, this is only an example and should not be construed as limiting. Alternatively, the gyrosensor 130 may be arranged in the second module 20a (fixed unit 20). This allows the camera device 1 to detect the orientation of the first module (movable unit) 10 based on the angle formed by the second module 20a (fixed unit 20) and detected by the gyrosensor 130 and on the relative angle defined by the second module 20a with respect to the first module (movable unit) 10 and detected by the magnetic sensor 92.

The camera control unit 112 controls the camera module 3. For example, if the camera device 1 has accepted, at the operating unit 5, a user's command that image capturing should be started, the camera control unit 112 controls the camera module 3 to make the camera module 3 start capturing an image. Specifically, the camera control unit 112 starts processing the video signal output from the image sensor 3a. On the other hand, if the camera device 1 has accepted, at the operating unit 5, a user's command that image capturing should be aborted, the camera control unit 112 controls the camera module 3 to make the camera module 3 finish (abort) capturing an image. The camera control unit 112 also has the capability of storing video data (video signal) in a built-in memory of the camera device 1 or a storage medium such as a memory card.

In the embodiment described above, the driving control unit 111 and the camera control unit 112 are implemented as a single microcontroller. However, this configuration is only an example and should not be construed as limiting. Alternatively, the camera control unit 112 may also be implemented as another microcontroller separately from the driving control unit 111.

The first driver unit 120 is a driver circuit that receives the first drive signal from the driving control unit 111 and instructs the panning driving unit 30a, the tilting driving unit 30b, and the first rolling driving unit 30c to operate in accordance with the first drive signal. That is to say, the first driver unit 120 drives the movable unit 10 by supplying driving power to the panning driving unit 30a, the tilting driving unit 30b, and the first rolling driving unit 30c in accordance with the first drive signal.

The second driver unit 121 is a driver circuit that receives the second drive signal from the driving control unit 111 and instructs the second rolling driving unit 35 to operate in accordance with the second drive signal. That is to say, the second driver unit 121 drives the mounting unit 100 by supplying driving power to the second rolling driving unit 35 in accordance with the second drive signal.

The battery 150 may be implemented as a storage battery, for example, and supplies power to drive the camera device 1.

In this embodiment, as shown in FIG. 1, the panning drive magnet 31a, the tilting drive magnet 31b, the first rolling drive magnet 31c, the gyrosensor 130, and the acceleration sensor 131 together form the movable unit 10. In addition, the fixed unit 20, the second rolling drive coil 37, the second driver unit 121, and the battery 150 together form the second module 20a. The panning drive coil 32a, the tilting drive coil 32b, the first rolling drive coil 32c, the control unit 110, and the first driver unit 120 together form the fixed unit 20. Furthermore, the second rolling drive magnet 36 constitutes the mounting unit 100.

Thus, the second module 20a includes the fixed unit 20 and the second rolling drive coil 37, and therefore, a signal line required for rotational drive may be installed within the second module 20a. That is to say, there is no need to extend the signal line to any external device (such as the mounting unit 100) in order to drive the camera device 1 in rotation.

In addition, the second module 20a includes the second rolling drive coil 37 (i.e., a plurality of coils 37a) and the battery 150, and therefore, wires for supplying electricity to the second rolling drive coil 37 may be installed within the second module 20a. Furthermore, the second holding mechanism 141 implemented as a bearing is provided for the mounting unit 100. These electrical and mechanical configurations allow the plurality of magnets 36a to rotate around the optical axis 1a with respect to the plurality of coils 37a with the movable range expanded to 360 degrees or more. In other words, these electrical and mechanical configurations allow the image capturing unit body 10a to rotate relative to the mounting unit 100.

(3) Exemplary Structure for Camera Device

Next, a specific structure for the camera device 1 according to this embodiment (an exemplary structure for the movable unit 10 and the fixed unit 20, among other things) will be described with reference to FIGS. 3A-6.

The camera module 3 includes an image sensor 3a, a lens 3b for forming a subject image on the image capturing plane of the image sensor 3a, and a lens barrel 3c for holding the lens 3b (see FIG. 4). The lens barrel 3c protrudes from the actuator 2 along the optical axis 1a of the camera module 3. The lens barrel 3c has a circular cross section when taken perpendicularly to the optical axis 1a. Also, a plurality of cables electrically connected to the camera module 3 includes coplanar waveguides or micro-strip lines. Alternatively, the plurality of cables may include fine-line coaxial cables each having the same length. Those cables are grouped into a predetermined number of bundles of cables 11.

The camera device 1 includes an upper ring 4, a movable unit 10, a fixed unit 20, a driving unit 30, and a printed circuit board 90 as shown in FIGS. 3A and 4.

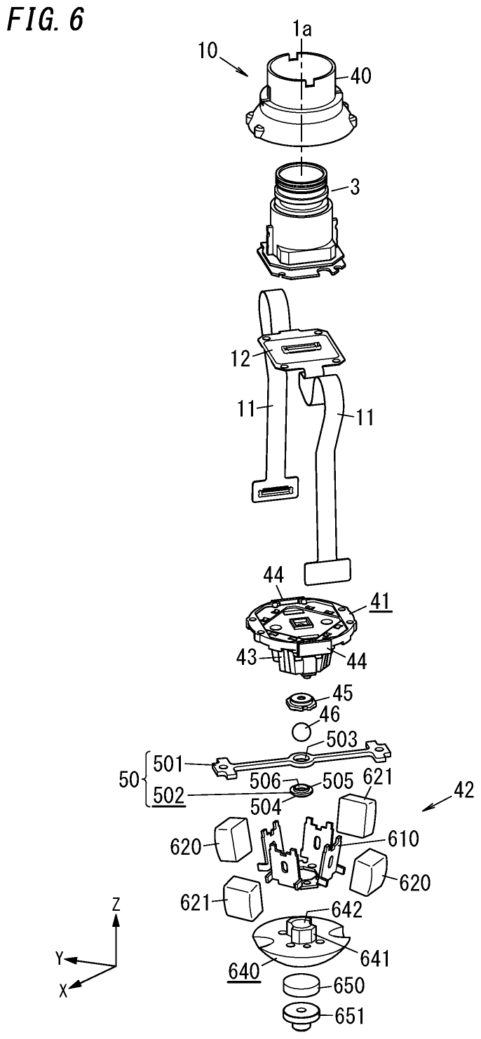

The movable unit 10 includes a camera holder 40, a first movable base 41, and a second movable base 42 (see FIG. 6). The movable unit 10 is fitted to the fixed unit 20 with some gap left between the movable unit 10 and the fixed unit 20. The movable unit 10 rotates (i.e., rolls) around the optical axis 1a of the lens of the camera module 3 with respect to the fixed unit 20.

In the following description, a position of the movable unit 10 (camera module 3) not driven by the driving unit 30 (i.e., the position shown in FIG. 3A and other drawings) will be defined herein to be a “neutral position.” In this embodiment, the direction in which the optical axis 1a extends when the movable unit 10 is in the neutral position will be hereinafter referred to as a “Z-axis direction.” The Z-axis direction is aligned with a fitting direction in which the movable unit 10 is fitted to the fixed unit 20. Furthermore, the direction in which the lens barrel 3c protrudes from the movable unit 10 along the Z-axis will be hereinafter referred to as an “upward direction.” That is to say, the movable unit 10 in the neutral position is rotatable around the Z-axis. The movable unit 10 also rotates around X- and Y-axes with respect to the fixed unit 20. In this case, both of the X- and Y-axes are perpendicular to the Z-axis. In addition, the X- and Y-axes are perpendicular to each other.

In the following description, the direction in which the movable unit 10 (camera module 3) rotates around the X-axis is defined herein to be a “panning direction” and the direction in which the movable unit 10 (camera module 3) rotates around the Y-axis is defined herein to be a “tilting direction.” Furthermore, the direction in which the movable unit 10 (camera module 3) rotates (rolls) around the optical axis 1a is defined herein to be a “rolling direction.” A detailed configuration of the movable unit 10 will be described later. Note that all of the optical axis 1a and the X-, Y-, and Z-axes are virtual axes, and the arrows indicating the X-, Y-, and Z-axes on the drawings are just shown there for the sake of description and are insubstantial ones. It should also be noted that these directions should not be construed as limiting the directions in which the camera device 1 is used.

The camera module 3 is attached to the camera holder 40. The configuration of the first movable base 41 and the second movable base 42 will be described later. Rotation of the movable unit 10 allows the camera module 3 to rotate as well.

The fixed unit 20 includes a coupling member 50 and a body 51 (see FIG. 5).

The coupling member 50 includes a linear coupling bar 501 and a loosely fitting member 502 (see FIG. 6). The coupling bar 501 has an opening 503 cut through a middle of the length thereof. The loosely fitting member 502 includes a base 504 and a wall 505 (see FIG. 6). When viewed downward from over the base 504 (i.e., in a plan view), the base 504 has a circular shape. One surface, closer to the camera module 3, of the base 504 (i.e., its upper surface) is a flat surface, while the other surface, more distant from the camera module 3, of the base 504 (i.e., its lower surface) is a spherical surface. A central portion of the upper surface of the base 504 has a recess 506 (see FIG. 6). The wall 505 protrudes upward from around the recess 506 of the base 504 (see FIG. 6). The inner peripheral surface of the wall 505, i.e., the surface facing the recess 506, constitutes a second loosely fitting surface 507 (to be described later) (see FIG. 6). The diameter of the outer periphery of the wall 505 is approximately equal to the diameter of the opening 503 of the coupling bar 501. The wall 505 is fitted to the opening 503 of the coupling bar 501.

The body 51 includes a pair of protrusions 510. The pair of protrusions 510 are provided so as to face each other in a direction perpendicular to the Z-axis and forming an angle of 45 degrees with respect to the X- and Y-axes. The pair of protrusions 510 is also provided to be located in the gaps between first coil units 52 and second coil units 53 arranged (to be described later). The coupling member 50 is screwed onto the body 51 with the second movable base 42 interposed between itself and the body 51. Specifically, both longitudinal ends of the coupling member 50 are respectively screwed onto the pair of protrusions 510 of the body 51.

The body 51 is provided with two fixing portions 703 for fixing the two bundles of cables 11 thereto (see FIGS. 3A and 4). The two fixing portions 703 are arranged to face each other in a direction perpendicular to not only the Z-axis but also the direction in which the pair of protrusions 510 face each other. The two fixing portions 703 are provided to tilt with respect to the Z-axis such that the interval between the two fixing portions 703 broadens toward the camera module 3 in the Z-axis direction (see FIG. 5). Each of the two fixing portions 703 includes a first member 704 and a second member 705, both of which are formed in a plate shape. An associated bundle of cables 11 is partially clamped between the first and second members 704 and 705.

The fixed unit 20 includes a pair of first coil units 52 and a pair of second coil units 53 to make the movable unit 10 electromagnetically drivable and rotatable (see FIG. 3B). The pair of first coil units 52 face each other in the Y-axis direction. The pair of second coil units 53 face each other in the X-axis direction. The pair of first coil units 52 allows the movable unit 10 to rotate around the X-axis. The pair of second coil units 53 allows the movable unit 10 to rotate around the Y-axis.

The pair of first coil units 52 each include a first magnetic yoke 710 made of a magnetic material, drive coils 720 and 730, and magnetic yoke holders 740 and 750 (see FIG. 5). Each of the first magnetic yokes 710 has the shape of an arc, of which the center is defined by the center of rotation 460 (see FIG. 4). The drive coils 730 are each formed by winding a conductive wire around its associated first magnetic yoke 710 such that its winding direction is defined around the X-axis (i.e., the direction in which the second coil units 53 face each other) and that the pair of first drive magnets 620 (to be described later) is driven in rotation in the rolling direction. As used herein, the winding direction of the coil refers in this embodiment to a direction in which the number of turns increases. Furthermore, the magnetic yoke holders 740 and 750 are secured with screws onto the first magnetic yoke 710 on both sides thereof. Thereafter, the drive coils 720 are each formed by winding a conductive wire around its associated first magnetic yoke 710 such that its winding direction is defined around the Z-axis and that the pair of first drive magnets 620 is driven in rotation in the panning direction. Then, the pair of first coil units 52 is secured with screws onto the body 51 so as to face each other when viewed from the camera module 3. Specifically, each of the first coil units 52 has one end thereof along the Z-axis (i.e., the end opposite from the camera module 3) secured with a screw onto the body 51. Each of the first coil units 52 has the other end thereof along the Z-axis (i.e., the end closer to the camera module 3) fitted to the upper ring 4.

The pair of second coil units 53 each include a second magnetic yoke 711 made of a magnetic material, drive coils 721 and 731, and magnetic yoke holders 741 and 751 (see FIG. 5). Each of the second magnetic yokes 711 has the shape of an arc, of which the center is defined by the center of rotation 460 (see FIG. 4). The drive coils 731 are each formed by winding a conductive wire around its associated second magnetic yoke 711 such that its winding direction is defined around the Y-axis (i.e., the direction in which the first coil units 52 face each other) and that the pair of second drive magnets 621 (to be described later) is driven in rotation in the rolling direction. Furthermore, the magnetic yoke holders 741 and 751 are secured with screws onto the second magnetic yoke 711 on both sides thereof. Thereafter, the drive coils 721 are each formed by winding a conductive wire around its associated second magnetic yoke 711 such that its winding direction is defined around the Z-axis and that the pair of second drive magnets 621 is driven in rotation in the tilting direction. Then, the pair of second coil units 53 is secured with screws onto the body 51 so as to face each other when viewed from the camera module 3. Specifically, each of the second coil units 53 has one end thereof along the Z-axis (i.e., the end opposite from the camera module 3) secured with a screw onto the body 51. Each of the second coil units 53 has the other end thereof along the Z-axis (i.e., the end closer to the camera module 3) fitted to the upper ring 4.

The camera holder 40 on which the camera module 3 has been mounted is secured with screws onto the first movable base 41. The coupling member 50 is interposed between the first movable base 41 and the second movable base 42.

The printed circuit board 90 includes a plurality of (e.g., four in this embodiment) magnetic sensors 92 for detecting rotational positions in the panning and tilting directions of the camera module 3. In this embodiment, the magnetic sensors 92 may be implemented as Hall elements, for example. However, this is only an example and should not be construed as limiting. Alternatively, the magnetic sensors 92 may also be sensors using magnetoresistance elements or coils, for example.

On the printed circuit board 90, further assembled are a circuit for controlling the amount of a current to flow through the drive coils 720, 721, 730, and 731 and other circuits. Examples of the other circuits assembled on the printed circuit board 90 include a circuit having the capability of the first driver unit 120 shown in FIG. 1 and a circuit having the capability of the second driver unit 121 shown in FIG. 1. A microcontroller or any other microprocessor may be further built on the printed circuit board 90. In other words, although not shown in FIGS. 4, 5, and other drawings, the control unit 110 is provided for the printed circuit board 90.

Next, detailed configurations for the first movable base 41 and the second movable base 42 will be described.

The first movable base 41 includes a body 43, a pair of holding portions 44, a loosely fitting member 45, and a sphere 46 (see FIG. 6). The body 43 sandwiches a rigid portion 12 between itself and the camera holder 40 to fix (hold) the rigid portion 12 thereon. The respective holding portions 44 are provided for the peripheral edge of the body 43 so as to face each other (see FIG. 6). Each holding portion 44 clamps and holds an associated bundle of cables 11 between itself and a sidewall 431 of the body 43 (see FIG. 4). The loosely fitting member 45 has a through hole 451 running through the loosely fitting member 45 in the Z-axis direction (see FIG. 4). The inner peripheral surface of the through hole 451 is tapered such that the through hole 451 increases its diameter along the Z-axis in a direction going away from the camera module 3.

The sphere 46 is fitted and fixed into the through hole 451 of the loosely fitting member 45 and has a first loosely fitting surface 461 as a raised spherical surface (see FIG. 4). The sphere 46 is loosely fitted to the loosely fitting member 502 such that a narrow gap is left between the first loosely fitting surface 461 and a second loosely fitting surface 507 of the loosely fitting member 502 (i.e., the inner peripheral surface of the wall 505). This allows the coupling member 50 to pivotally support the movable unit 10 to make the movable unit 10 rotatable. Pivotally supporting the movable unit 10 not only allows the movable unit 10 to freely rotate in the panning and tilting directions but also reduces friction during rotation because the area of contact is small. In this case, the center of mass of the sphere 46 defines the center of rotation 460 of the movable unit 10. This configuration for pivotally supporting the movable unit 10 so as to allow the movable unit 10 to rotate freely corresponds to the first holding mechanism 140 described above.

The second movable base 42 supports the first movable base 41. The second movable base 42 includes a back yoke 610, a pair of first drive magnets 620, and a pair of second drive magnets 621 (see FIG. 6). The second movable base 42 further includes a bottom plate 640, a position detecting magnet 650, and a stopper member 651 (see FIG. 6).

The back yoke 610 includes a disk portion and four fixing portions (arms) extending from the outer periphery of the disk portion toward the camera module 3 (i.e., upward). Two out of the four fixing portions face each other along the X-axis, while the other two fixing portions face each other along the Y-axis. The two fixing portions facing each other along the Y-axis respectively face the pair of first coil units 52. The two fixing portions facing each other along the X-axis respectively face the pair of second coil units 53.

The pair of first drive magnets 620 are respectively fixed to two fixing portions, facing each other along the Y-axis, out of the four fixing portions of the back yoke 610. The pair of second drive magnets 621 are respectively fixed to two fixing portions, facing each other along the X-axis, out of the four fixing portions of the back yoke 610.

Electromagnetic driving by the first drive magnets 620 and the first coil units 52 and electromagnetic driving by the second drive magnets 621 and the second coil units 53 allow the movable unit 10 (camera module 3) to rotate in the panning, tilting, and rolling directions. Specifically, electromagnetic driving by the two drive coils 720 and the two first drive magnets 620 allows the movable unit 10 to rotate in the panning direction, and electromagnetic driving by the two drive coils 721 and the two second drive magnets 621 allows the movable unit 10 to rotate in the tilting direction. Meanwhile, electromagnetic driving by the two drive coils 730 and the two first drive magnets 620 and electromagnetic driving by the two drive coils 731 and the two second drive magnets 621 allow the movable unit 10 to rotate in the rolling direction.

The bottom plate 640 is a non-magnetic member and may be made of brass, for example. The bottom plate 640 is attached to the back yoke 610 to define the bottom of the movable unit 10 (i.e., the bottom of the second movable base 42). The bottom plate 640 is secured with screws onto the back yoke 610 and the first movable base 41. The bottom plate 640 serves as a counterweight. Having the bottom plate 640 serve as a counterweight allows the center of rotation 460 to agree with the center of gravity of the movable unit 10. That is why when external force is applied to the entire movable unit 10, the moment of rotation of the movable unit 10 around the X-axis and the moment of rotation of the movable unit 10 around the Y-axis both decrease. This allows the movable unit 10 (or the camera module 3) to be held in the neutral position, or to rotate around the X- and Y-axes, with less driving force.

One surface, located closer to the camera module 3 (i.e., the upper surface), of the bottom plate 640 is a flat surface, and a central portion of the upper surface has a projection 641. The projection 641 has a recess 642 at the tip. The bottom of the recess 642 is a downwardly protruding, curved surface. The loosely fitting member 502 is located closer to the camera module 3 than (i.e., arranged over) the recess 642 (see FIG. 4).

The other surface, located more distant from the camera module 3 (i.e., the lower surface), of the bottom plate 640 is a spherical surface, and a central portion of the lower surface has a recess. In the recess, arranged are the position detecting magnet 650 and the stopper member 651 (see FIG. 4). The stopper member 651 prevents the position detecting magnet 650, arranged in the recess of the bottom plate 640, from falling off.

A gap is left between the recess 642 of the bottom plate 640 and the loosely fitting member 502 (see FIG. 4). The bottom of the recess 642 of the bottom plate 640 and the lower surface of the base 504 of the loosely fitting member 502 are curved surfaces that face each other. This gap is wide enough to allow, even when the loosely fitting member 502 comes into contact with the bottom plate 640, the first drive magnets 620 and the second drive magnets 621 to go back to their home positions due to their own magnetism. Thus, even if the camera module 3 has moved along the Z-axis, the movable unit 10 (camera module 3) is still able to go back to its home position.

The four magnetic sensors 92 provided for the printed circuit board 90 detect, based on the relative position of the position detecting magnet 650 with respect to the four magnetic sensors 92, the relative rotation (movement) of the movable unit 10 with respect to the fixed unit 20. That is to say, as the movable unit 10 rotates (moves), the position detecting magnet 650 changes its position, thus causing a variation in the magnetic force applied to the four magnetic sensors 92. The four magnetic sensors 92 detect this variation in the magnetic force, and calculate two-dimensional angles of rotation with respect to the X- and Y-axes. This allows the four magnetic sensors 92 to detect the angles of rotation of the movable unit 10 in the tilting and panning directions.

Optionally, the rotation in the rolling direction of the movable unit 10 may be estimated by the force that causes the movable unit 10 to try to return to the origin (i.e., the stability point) under the magnetic attraction produced between the movable unit 10 and the fixed unit 20, i.e., by so-called “magnetic spring.” That is to say, the camera device 1 may estimate, based on DC components (low frequency components) of either the drive signal or a signal output from the first driver unit 120 to the drive coils 730 and 731, the relative rotation (movement) in the rolling direction of the movable unit 10 with respect to the fixed unit 20.

In this case, the pair of first drive magnets 620 serves as attracting magnets, thus producing first magnetic attraction forces between the pair of first drive magnets 620 and the first magnetic yokes 710 that face the first drive magnets 620. Likewise, the pair of second drive magnets 621 also serves as attracting magnets, thus producing second magnetic attraction forces between the pair of second drive magnets 621 and the second magnetic yokes 711 that face the second drive magnets 621. The vector direction of each of the first magnetic attraction forces is parallel to a centerline that connects together the center of rotation 460, the center of mass of an associated one of the first magnetic yokes 710, and the center of mass of an associated one of the first drive magnets 620. The vector direction of each of the second magnetic attraction forces is parallel to a centerline that connects together the center of rotation, the center of mass of an associated one of the second magnetic yokes 711, and the center of mass of an associated one of the second drive magnets 621.

The first and second magnetic attraction forces become normal forces produced by the fixed unit 20 with respect to the sphere 46 of the loosely fitting member 502. Also, when the movable unit 10 is in the neutral position, the magnetic attraction forces of the movable unit 10 define a synthetic vector in the Z-axis direction. This force balance between the first magnetic attraction forces, the second magnetic attraction forces, and the synthetic vector resembles the dynamic configuration of a balancing toy, and allows the movable unit 10 to rotate in three axis directions with good stability.

In this embodiment, the pair of first coil units 52, the pair of second coil units 53, the pair of first drive magnets 620, and the pair of second drive magnets 621 together form the driving unit 30. The driving unit 30 includes the panning driving unit 30a, the tilting driving unit 30b, and the first rolling driving unit 30c.

The panning driving unit 30a is constituted of the pair of first magnetic yokes 710 and pair of drive coils 720 included in the pair of first coil units 52, and the pair of first drive magnets 620. That is to say, the pair of first drive magnets 620 corresponds to the panning drive magnet 31a, and the pair of drive coils 720 corresponds to the panning drive coil 32a.

The tilting driving unit 30b is constituted of the pair of second magnetic yokes 711 and pair of drive coils 721 included in the pair of second coil units 53, and the pair of second drive magnets 621. That is to say, the pair of second drive magnets 621 corresponds to the tilting drive magnet 31b, and the pair of drive coils 721 corresponds to the tilting drive coil 32b.

The first rolling driving unit 30c is constituted of the pair of first drive magnets 620, the pair of second drive magnets 621, the pair of first magnetic yokes 710, the pair of second magnetic yokes 711, the pair of drive coils 730, and the pair of drive coils 731. That is to say, the pair of first drive magnets 620 and the pair of second drive magnets 621 correspond to the first rolling drive magnet 31c, and the pair of drive coils 730 and the pair of drive coils 731 correspond to the first rolling drive coil 32c.

The camera device 1 of this embodiment allows the movable unit 10 to rotate two-dimensionally (i.e., pan and tilt) by supplying electricity to the pair of drive coils 720 and the pair of drive coils 721 simultaneously. In addition, the camera device 1 also allows the movable unit 10 to rotate (i.e., to roll) around the optical axis 1a by supplying electricity to the pair of drive coils 730 and the pair of drive coils 731 simultaneously.

In the embodiment described above, the image capturing unit body 10a is supposed to rotate around the optical axis 1a with respect to the mounting unit 100 with the movable range expanded to 360 degrees or more. However, this configuration is only an example and should not be construed as limiting. Alternatively, the image capturing unit body 10a may also rotate around the X-axis or Y-axis with respect to the mounting unit 100 with the movable range expanded to 360 degrees or more. For example, the plurality of coils 37a may be arranged, in the image capturing unit body 10a, along the circumference of a circle centered around the X-axis (or Y-axis). The plurality of magnets 36a may be arranged, in the mounting unit 100, along the circumference of a circle centered around the X-axis (or Y-axis) so as to surround the plurality of coils 37a.

### Second Embodiment

A camera device according to a second exemplary embodiment will be described. In the camera device according to the second embodiment, the second module 20a may be split into two modules, which is a major difference from the first embodiment described above.

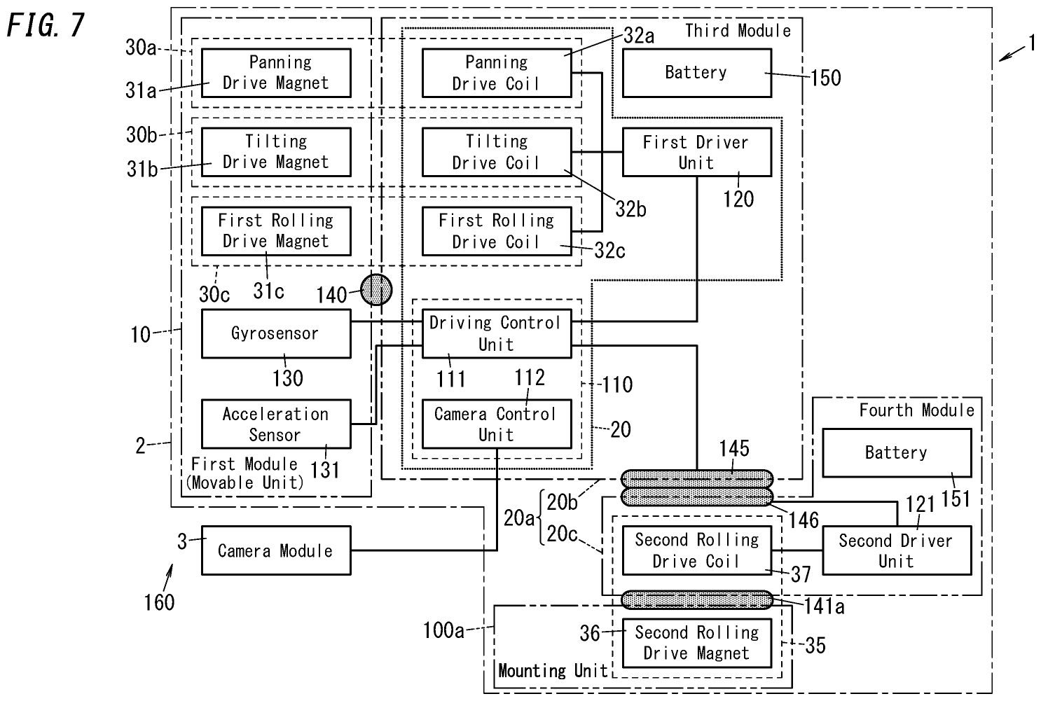

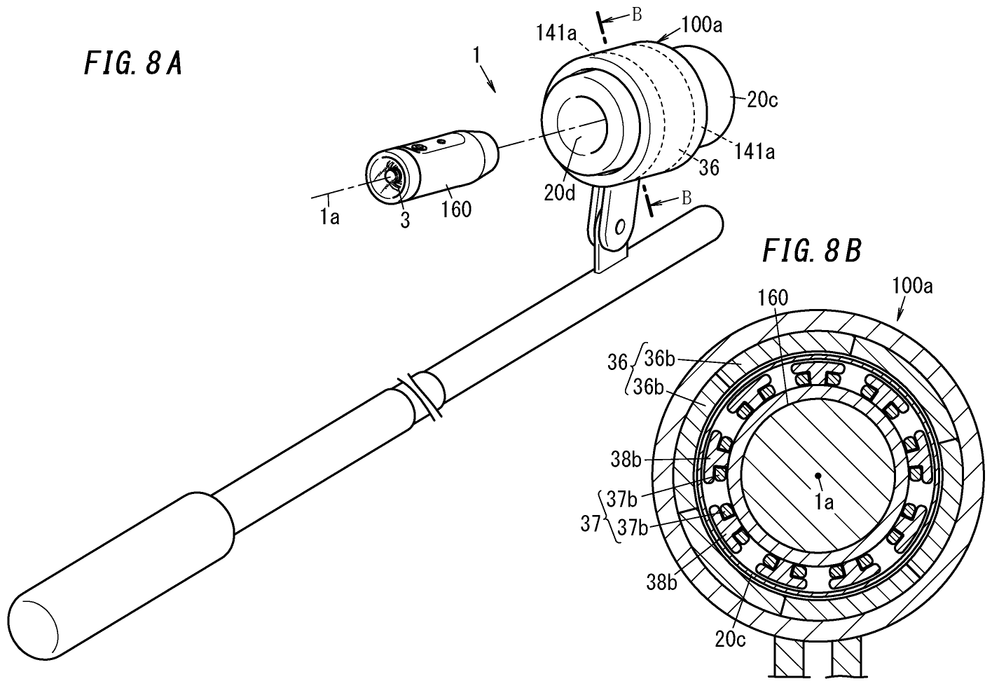

The second embodiment will now be described with reference to FIGS. 7-8B. The following description will be focused on differences of the second embodiment from the first embodiment. In the following description, any constituent element of this second embodiment, having the same function as a counterpart of the first embodiment described above, will be designated by the same reference numeral as that counterpart's, and description thereof will be omitted herein as appropriate.

The camera device 1 according to this embodiment includes the camera module 3, the movable unit (first module) 10, a second module 20a, and a mounting unit 100a as shown in FIG. 7.

The second module 20a according to this embodiment includes a third module 20b and a fourth module 20c.

The third module 20b holds the movable unit 10 rotatably via the first holding mechanism 140. That is to say, the first module (movable unit) 10 is loosely fitted to the third module 20b via the first holding mechanism 140.

The third module 20b is attachable to, and removable from, the fourth module 20c. In addition, the third module 20b further includes an electrically conductive connection member 145, which is electrically connected to the driving control unit 111 of the control unit 110 and the battery 150.

The camera module 3, the movable unit 10, and the third module 20b together form a cylindrical image capturing unit body 160 as shown in FIG. 8A.

The image capturing unit body 160 includes the panning driving unit 30a, the tilting driving unit 30b, and the first rolling driving unit 30c. Specifically, the movable unit 10 includes the panning drive magnet 31a, the tilting drive magnet 31b, and the first rolling drive magnet 31c. The third module 20b includes the panning drive coil 32a, the tilting drive coil 32b, and the first rolling drive coil 32c. The third module 20b includes the control unit 110, the first driver unit 120, and the battery 150.

The fourth module 20c includes the second rolling drive coil 37 for the second rolling driving unit 35 and a battery 151. The battery 151 may be implemented as a storage battery, for example, and supplies, along with the battery 150, power to circuits when the third module 20b is attached to the fourth module 20c. The fourth module 20c includes an electrically conductive connection member 146, which is electrically connected to the second driver unit 121 and the battery 151.

The fourth module 20c has the shape of a cylinder with an opening 20d, to which the image capturing unit body 160 is attachable as shown in FIG. 8A. The fourth module 20c includes a locking mechanism for preventing the image capturing unit body 160 (third module 20b) that has been inserted into the opening 20d from falling off. Having the third module 20b attached locked by the locking mechanism prevents the third module 20b from falling off from the fourth module 20c. When the third module 20b needs to be removed from the fourth module 20c, the locking mechanism just needs to be unlocked.

The mounting unit 100a with a tool to be used by a shooter to capture an image of him- or herself (i.e., a so-called “selfie stick”) is attachable to the fourth module 20c. The mounting unit 100a is fitted (i.e., attached) so as to surround the outer periphery of the fourth module 20c and hold the fourth module 20c thereon.

When the third module 20b is attached to the fourth module 20c, the connection member 145 of the third module 20b and the connection member 146 of the fourth module 20c are connected to each other. This allows the third module 20b and the fourth module 20c to be electrically connected together. Specifically, the second driver unit 121, the battery 151, and the third module 20b are electrically connected together, and the driving control unit 111, the battery 150, and the fourth module 20c are also electrically connected together.

The camera device 1 according to this embodiment further includes a second holding mechanism 141a for holding the image capturing unit body 160 such that the image capturing unit body 160 is rotatable around the optical axis 1a with respect to the mounting unit 100a with the movable range expanded to 360 degrees or more (see FIG. 8A). The mounting unit 100a holds the image capturing unit body 160 via the second holding mechanism 141a that is rotatable around the optical axis 1a. The second holding mechanism 141a may be implemented as a bearing, for example. In this embodiment, two second holding mechanisms 141a are arranged along the optical axis 1a on the inner peripheral surface of the mounting unit 100a so as to interpose the second rolling drive magnet 36 that the second rolling driving unit 35 includes (see FIG. 8A). This allows the camera device 1 to hold the image capturing unit body 160 such that the image capturing unit body 160 is rotatable with respect to the mounting unit 100a.

The second rolling driving unit 35 according to this embodiment will be described with reference to FIGS. 8A and 8B. FIG. 8B is a cross-sectional view schematically illustrating a cross section taken along a plane including the line segment B-B and perpendicular to the optical axis 1a. Note that in FIG. 8B, the configuration of the image capturing unit body 160 is not shown in detail but is just represented by hatching for the sake of convenience.

As shown in FIG. 8B, the fourth module 20c is provided with a plurality of coils 37b arranged along the circumference of a circle centered around the optical axis 1a. Specifically, the fourth module 20c includes a plurality of yokes 38b, which are arranged along the circumference of the circle centered around the optical axis 1a. Winding a conductive wire around each of the plurality of yokes 38b allows a coil 37b to be formed.

In addition, as shown in FIG. 8B, a plurality of magnets 36b are provided for the mounting unit 100a so as to be arranged along the circumference of another circle centered around the optical axis 1a and to surround the plurality of coils 37b.

The fourth module 20c has a very small thickness (see FIG. 8B), which prevents the gap between the second rolling drive coil 37 and the second rolling drive magnet 36 from widening.

The second rolling drive coil 37 according to this embodiment is constituted of the plurality of coils 37b. The second rolling drive magnet 36 according to this embodiment is constituted of the plurality of magnets 36b. In short, the second rolling driving unit 35 according to this embodiment is implemented as a brushless motor of an outer rotor type. Energizing the plurality of coils 37b causes the plurality of magnets 36b to rotate around the optical axis 1a with respect to the plurality of coils 37b with the movable range expanded to 360 degrees or more. In other words, the image capturing unit body 160 rotates relative to the mounting unit 100a.

In this embodiment, the second module 20a is constituted of the third module 20b and the fourth module 20c, and the third module 20b is attachable to, and removable from, the fourth module 20c. However, this configuration is only an example and should not be construed as limiting. Alternatively, the second module 20a may also be implemented as an integrated one that is not separable into two modules.

Optionally, the configuration of this embodiment may be applied to the camera device 1 according to the first embodiment. That is to say, in the camera device 1 described as the first embodiment, the second module 20a may be constituted of the third module 20b and the fourth module 20c, and the third module 20b may be attachable to, and removable from, the fourth module 20c.

Also, in the camera device 1 according to the embodiment described above, when attached to the fourth module 20c, the third module 20b is supposed to be attached along the optical axis 1a of the camera module 3. However, this configuration is only an example and should not be construed as limiting. Optionally, the third module 20b may be attached to the fourth module 20c along the X-axis or the Y-axis, i.e., in the direction perpendicular to the optical axis 1a as well.

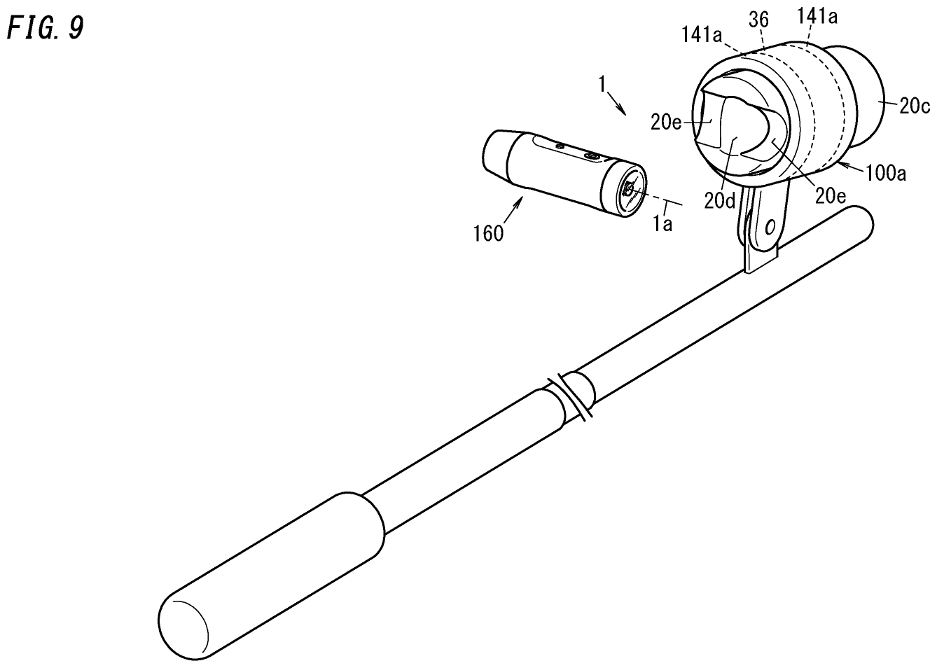

In that case, both ends, perpendicular to the insertion direction, at the tip of the fourth module 20c may have cutouts 20e to make the third module 20b attachable perpendicularly to the optical axis 1a (see FIG. 9). Bringing an outer peripheral portion of the image capturing unit body 160 (third module 20b) into abutment with the cutouts 20e allows the image capturing unit body 160 (third module 20b) to be attached to the fourth module 20c perpendicularly to the optical axis 1a. In this case, a mechanism similar to the locking mechanism described above also prevents the third module 20b attached from falling off. In addition, the third module 20b and the fourth module 20c are configured to be electrically connected together when the third module 20b is attached to the fourth module 20c in the direction perpendicular to the optical axis 1a.

Optionally, the control unit 110 may detect the mode of attachment of the image capturing unit body 160 (third module 20b) to the fourth module 20c. For example, if a point of electrical connection between the third module 20b and the fourth module 20c is changed according to the mode of attachment, then the mode of attachment is distinguishable. Detecting the mode of attachment allows the axis of the gyrosensor 130 for use to control the second rolling driving unit 35 to be switched, thus making this actuator 2 even handier for users.

Optionally, according to this embodiment, the third module 20b may include an attachment/removal detection unit for detecting the attachment or removal of the image capturing unit body 160 (third module 20b) to/from the fourth module 20c. In that case, when detecting the attachment to the fourth module 20c, the third module 20b disables the rotation in the rolling direction by the first rolling driving unit 30c. On the other hand, when detecting the removal from the fourth module 20c, the third module 20b enables the rotation in the rolling direction by the first rolling driving unit 30c. This allows power to be saved when the third module 20b is attached to the fourth module 20c.

Furthermore, in the embodiment described above, the battery 151 is provided for the fourth module 20c. However, this is only an example and should not be construed as limiting. Alternatively, the battery 151 may be provided for the mounting unit 100a. Still alternatively, the battery 151 may also be provided for both of the fourth module 20c and the mounting unit 100a. Providing the battery 151 for either the fourth module 20c or the mounting unit 100a or both of them reduces the overall weight when the image capturing unit body 160 is used by itself, and allows the actuator 2 to be used for a longer time when the image capturing unit body 160 is used to be attached to the fourth module 20c.

Furthermore, in the embodiment described above, the battery 151 is used in common for the third module 20b and the fourth module 20c. However, this is only an example and should not be construed as limiting. Alternatively, the battery 151 may be dedicated to the fourth module 20c. In that case, only the second drive signal is supplied from the third module 20b and the power to drive the second rolling drive coil 37 is supplied from the battery 151 of the fourth module 20c. This makes the voltages supplied by the third module 20b and the fourth module 20c different from each other, thus allowing the second rolling drive coil 37 having the greater inertial force and requiring higher power to be driven at a high voltage.

As in the first embodiment described above, the second module 20a also includes the fixed unit 20 and the second rolling drive coil 37 in this embodiment as well, and therefore, the signal line required for rotational drive may be installed within the second module 20a. This eliminates the need of extending the signal line to any external device (such as the mounting unit 100a) to drive the actuator 2 in rotation.

In addition, the second module 20a includes the second rolling drive coil 37 (i.e., a plurality of coils 37b) and the battery 150, and therefore, wires for supplying electricity to the second rolling drive coil 37 may be installed within the second module 20a. Furthermore, the second holding mechanism 141 implemented as a bearing is provided for the mounting unit 100a. These electrical and mechanical configurations allow the plurality of magnets 36b to rotate around the optical axis 1a with respect to the plurality of coils 37b with the movable range expanded to 360 degrees or more. In other words, these electrical and mechanical configurations allow the image capturing unit body 160 to rotate relative to the mounting unit 100a.

(Variations)

Note that the embodiment described above is only an example of various embodiments of the present disclosure and should not be construed as limiting. Rather, the embodiment may be readily modified in various manners, depending on a design choice or any other factor, without departing from a scope of the present invention.

In the embodiments described above, the second rolling driving unit 35 is suitably arranged in the vicinity of the center of gravity of the movable unit 10 and fixed unit 20. This reduces the imbalance of the force applied to the second holding mechanism 141 (141a) and stabilizes the frictional resistance during rotation, thus extending the life of the actuator.

In the embodiments described above, the second rolling driving unit 35 is implemented as a brushless motor. However, this is only an example and should not be construed as limiting. Alternatively, the second rolling driving unit 35 may also be implemented as a brush motor.

In the embodiments described above, the movable unit 10 is configured to be rotatable in the three axis directions (namely, the panning direction, the tilting direction, and the rolling direction) with respect to the fixed unit 20. However, this configuration is only an example and should not be construed as limiting. The movable unit 10 only needs to be rotatable in at least two out of the three axis directions that are the panning, tilting and rolling directions with respect to the fixed unit. In particular, the movable unit 10 may be configured to be rotatable in at least the panning and tilting directions with respect to the fixed unit.

Also, in the embodiments described above, the second holding mechanism 141 (141a) is implemented as a bearing. However, this configuration is only an example and should not be construed as limiting. Rather, the second holding mechanism 141 (141a) only needs to be a mechanism with the ability to hold the image capturing unit body 10a (160) rotatably.

Furthermore, in the embodiments described above, the movable unit 10 is pivotally supported by the coupling member 50 of the fixed unit 20 so as to make the movable unit 10 rotatable. However, this is not the only configuration that allows the fixed unit 20 to hold the movable unit 10 such that the movable unit 10 is rotatable (movable). Alternatively, the movable unit 10 may also have a raised partially spherical surface and may be supported rotatably by the fixed unit 20 having a recess in which at least part of the movable unit 10 is loosely fitted. This allows the movable unit 10 to freely rotate in the panning and tilting directions. In addition, this also broadens the space to accommodate the camera module 3 in the movable unit 10.

Furthermore, in the embodiments described above, the actuator 2 is combined with the camera module 3. However, this is only an example and should not be construed as limiting. Alternatively, the actuator 2 may also be combined with a laser pointer, a projector, a haptic device, or any other type of device as well.

(Resume)

As can be seen from the foregoing description, an actuator (2) according to a first aspect includes a first module (10), a second module (20a), and a mounting unit (100, 100a). The first module (10) includes a first magnet (such as a panning drive magnet 31a) and a second magnet (such as a tilting drive magnet 31b). The second module (20a) supports the first module (10) to make the first module (10) rotatable around each of a first axis (such as an X-axis) and a second axis (such as a Y-axis) perpendicular to the first axis. The mounting unit (100, 100a) includes a third magnet (such as a second rolling drive magnet 36) and supports the second module (20a) to make the second module (20a) rotatable. The second module (20a) has a movable range of 360 degrees or more with respect to the mounting unit (100, 100a). The second module (20a) includes a first coil (such as a panning drive coil 32a), a second coil (such as a tilting drive coil 32b), and a third coil (such as a second rolling drive coil 37). The first coil electromagnetically drives the first module (10) in rotation around the first axis with respect to the second module (20a) by generating magnetic force between the first coil itself and the first magnet. The second coil electromagnetically drives the first module (10) in rotation around the second axis with respect to the second module (20a) by generating magnetic force between the second coil itself and the second magnet. The third coil electromagnetically drives the mounting unit (100, 100a) in rotation with respect to the second module (20a) by generating magnetic force between the third coil itself and the third magnet.

According to this configuration, the respective coils to be supplied with electricity to electromagnetically drive the actuator are provided for the second module (20a), thus reducing the chances of making the wiring scheme overly complex. In addition, the second module has a movable range of 360 degrees or more, which is broader than known ones. This allows the actuator (2) to have a broader movable range while simplifying the wiring scheme.

In addition, in the known actuator (such as the camera driver of Patent Literature 1 cited in the Background Art), the camera unit has only a limited movable range. Particularly, when the camera unit is rotated in the rolling direction, the movable range is only about 5 degrees. Thus, the known actuator is certainly applicable to exercises with relatively small amplitude (such as walking or running) but is unsuitable to exercises with relatively large amplitude (such as sky diving, acrobatic actions, and other heavy physical exercises), motocross, and so on. In contrast, the actuator (2) described above is able to expand the movable range, and therefore, is applicable to such exercises with relatively large amplitude as well.

An actuator (2) according to a second aspect, which may be implemented in conjunction with the first aspect, further includes a detection unit (such as a gyrosensor 130 or a magnetic sensor 92) to detect an orientation of the first module (10). A rotational drive of the first module (10) around each of the first axis and the second axis is controlled based on a result of detection by the detection unit.

This configuration allows the actuator (2) to control the rotational drive of the first module (10) according to the orientation, detected by the detection unit, of the first module (10).

An actuator (2) according to a third aspect, which may be implemented in conjunction with the first or second aspect, further includes a sensor unit (such as an acceleration sensor 131) to detect acceleration of the first module (10) or the second module (20a). The first module (10) is controlled, based on a result obtained by the sensor unit, so as to face a certain direction with respect to gravity.

This configuration allows the actuator (2) to control, based on a result obtained by the sensor unit, the first module (10) such that the first module (10) faces a certain direction with respect to gravity.

An actuator (2) according to a fourth aspect, which may be implemented in conjunction with any one of the first to third aspects, further includes a first holding mechanism (140) and a second holding mechanism (141, 141a). The first holding mechanism (140) is rotatable around each of the first axis and the second axis and fits the second module (20a) into the first module (10). The second holding mechanism (141, 141a) fits the mounting unit (100, 100a) to the second module (20a) such that the mounting unit (100, 100a) is rotatable with respect to the second module (20a). The second module (20a) includes a first yoke (such as a first magnetic yoke 710) provided with the first coil and a second yoke (such as a second magnetic yoke 711) provided with the second coil. The second module (20a) sucks and holds the first module (10) thereon by magnetic attraction produced by the first yoke and the second yoke.

This configuration allows the second module (20a) to support the first module (10) rotatably.

In an actuator (2) according to a fifth aspect, which may be implemented in conjunction with any one of the first to fourth aspects, the second module (20a) is supported by the mounting unit (100, 100a) so as to be rotatable around a third axis that is perpendicular to both of the first axis and the second axis.

This configuration allows the actuator (2) to make the second module (20a) rotatable around the third axis.

In an actuator (2) according to a sixth aspect, which may be implemented in conjunction with the fifth aspect, the third coil is constituted of a plurality of drive coils (such as coils 37a, 37b). The third magnet is constituted of a plurality of drive magnets (such as magnets 36a, 36b). The plurality of drive coils are arranged, in the second module (20a), along a circumference of a circle centered around the third axis. The plurality of magnets are provided for the mounting unit (100, 100a) so as to be arranged along a circumference of another circle centered around the third axis and to surround the plurality of drive coils.

This configuration allows the actuator (2) to electromagnetically drive the second module (20a) in rotation around the third axis with respect to the mounting unit (100, 100a) with the movable range expanded to 360 degrees or more.

In an actuator (2) according to a seventh aspect, which may be implemented in conjunction with the fifth aspect, the third coil is constituted of a plurality of drive coils (such as coils 37a, 37b). The third magnet is constituted of a plurality of drive magnets (such as magnets 36a, 36b). The first module (10) is provided at one of two ends, defined along the third axis, of the second module (20a). The plurality of drive coils are arranged along a circumference of a circle centered around the third axis at the other of the two ends, defined along the third axis, of the second module (20a). The mounting unit (100) includes the plurality of drive magnets and is fitted to the second module (20a) at the other of the two ends thereof defined along the third axis. The plurality of drive magnets are provided for the mounting unit (100) and arranged along a circumference of another circle centered around the third axis so as to surround the plurality of drive coils.

This configuration allows the actuator (2) to electromagnetically drive the second module (20a) in rotation around the third axis with respect to the mounting unit (100) with the movable range expanded to 360 degrees or more.

In an actuator (2) according to an eighth aspect, which may be implemented in conjunction with any one of the first to seventh aspects, the first module (10) is electromagnetically driven in rotation with respect to the second module (20a) around a third axis that is perpendicular to both of the first axis and the second axis.

This configuration allows the actuator (2) to electromagnetically drive the first module (10) in rotation around the third axis with respect to the second module (20a). For example, the first module (10) may be rotated around the third axis with respect to the second module (20a) by being electromagnetically driven at high frequencies. In addition, the second module (20a) may also be rotated with respect to the mounting unit (100, 100a) by being electromagnetically driven at low frequencies. As described above, when rotating the first module (10) in the rolling direction with respect to the second module (20a), the known actuator has a movable range of only about 5 degrees. In general, the higher the frequency is, the smaller the amplitude tends to be. That is why high frequencies are suitably used when the movable range is small.

In an actuator (2) according to a ninth aspect, which may be implemented in conjunction with any one of the first to eighth aspects, the second module (20a) is constituted of a third module (20b) and a fourth module (20c). The third module (20b) is configured to be attachable to, and removable from, the fourth module (20c). The third module (20b) and the fourth module (20c) are electrically connected together when the third module (20b) is attached to the fourth module (20c). The third module (20b) is fitted to the first module (10) via a first holding mechanism (140) that is configured to be rotatable around the first axis and the second axis. The fourth module (20c) is fitted to the mounting unit (100, 100a) via a second holding mechanism (141, 141a) that is configured to be rotatable. The third module (20b) includes the first coil and the second coil. The fourth module (20c) includes the third coil.

This configuration allows, when the third module (20b) is separated from the fourth module (20c), the actuator (2) to be used as a smaller actuator (i.e., an actuator with a stabilizer function). This also allows, when the third module (20b) is attached to the fourth module (20c), the actuator (2) to be used as an actuator to be driven around the third axis and having a movable range of 360 degrees or more.

An actuator (2) according to a tenth aspect, which may be implemented in conjunction with any one of the first to ninth aspects, is used as a camera device (1). This configuration allows the actuator (2) to be used as a camera device (1) with the ability to expand the movable range while simplifying the wiring scheme.

A camera device (1) according to an eleventh aspect includes the actuator (2) of any one of the first to ninth aspects, and a camera module (3) arranged in the first module (10).

This configuration allows the camera device (1) to expand the movable range while simplifying the wiring scheme.

An actuator (2) according to a twelfth aspect includes a first module (10), a second module (20a), a first driving unit (such as a panning driving unit 30a), a second driving unit (such as a tilting driving unit 30b), a mounting unit (100, 100a), and a third driving unit (such as a second rolling driving unit 35). The first module (10) is rotatable around each of a first axis (such as an X axis) and a second axis (such as a Y axis) perpendicular to the first axis. The second module (20a) supports the first module (10) to make the first module (10) rotatable around the first axis and the second axis. The first driving unit includes a first coil (such as a panning drive coil 32a) and a first magnet (such as a panning drive magnet 31a) and electromagnetically drives the first module (10) in rotation around the first axis with respect to the second module (20a). The second driving unit includes a second coil (such as a tilting drive coil 32b) and a second magnet (such as a tilting drive magnet 31b) and electromagnetically drives the first module (10) in rotation around the second axis with respect to the second module (20a). The mounting unit (100, 100a) is to be fitted to the second module (20a). The third driving unit includes a third coil (such as a second rolling drive coil 37) and a third magnet (such as a second rolling drive magnet 36) and electromagnetically drives the second module (20a) in rotation around a third axis, which is perpendicular to both of the first axis and the second axis, with respect to the mounting unit (100, 100a) with a moving range expanded to 360 degrees or more. The first coil, the second coil, and the third coil are all provided for the second module (20a).

According to this configuration, the respective coils to be supplied with electricity to electromagnetically drive the actuator are provided for the second module (20a), thus reducing the chances of making the wiring scheme overly complex. In addition, the third driving unit has a movable range of 360 degrees or more, which is broader than known ones along the third axis. This allows the actuator (2) to have a broader movable range while simplifying the wiring scheme. The actuator (2) according to the twelfth aspect is able to expand the movable range along the third axis, for example.

In addition, in the known actuator (such as the camera driver of Patent Literature 1 cited in the Background Art), the camera unit has only a limited movable range in the three axis directions. Particularly, when the camera unit is rotated in the rolling direction, the movable range is only about 5 degrees. Thus, the known actuator is certainly applicable to exercises with relatively small amplitude (such as walking or running) but is unsuitable to exercises with relatively large amplitude (such as sky diving, acrobatic actions, and other heavy physical exercises), motocross, and so on. In contrast, the actuator (2) described above is able to expand the movable range in one (such as in the rolling direction) of the three axis directions, and therefore, is applicable to such exercises with relatively large amplitude as well.

An actuator (2) according to a thirteenth aspect, which may be implemented in conjunction with the twelfth aspect, further includes a detection unit (such as a gyrosensor 130 or a magnetic sensor 92) to detect an orientation of the first module (10). The first driving unit, the second driving unit, and the third driving unit control rotation based on a result of detection by the detection unit.

This configuration allows the actuator (2) to rotate the first module (10) according to the orientation, detected by the detection unit, of the first module (10).

An actuator (2) according to a fourteenth aspect, which may be implemented in conjunction with the twelfth or thirteenth aspect, further includes a sensor unit (such as an acceleration sensor 131) to detect acceleration of the first module (10) or the second module (20a). The first driving unit, the second driving unit, and the third driving unit control, based on a result obtained by the sensor unit, the first module (10) such that the first module (10) faces a certain direction with respect to gravity.

This configuration allows the actuator (2) to control, based on a result obtained by the sensor unit, the first module (10) such that the first module (10) faces a certain direction with respect to gravity.

An actuator (2) according to a fifteenth aspect, which may be implemented in conjunction with any one of the twelfth to fourteenth aspects, further includes a first holding mechanism (140) and a second holding mechanism (141, 141a). The first holding mechanism (140) is rotatable around each of the first axis and the second axis and fits the second module (20a) into the first module (10) with a gap left between the first module (10) and the second module (20a). The second holding mechanism (141, 141a) is rotatable around the third axis and fits the mounting unit (100, 100a) to the second module (20a). The second module (20a) includes a first yoke (such as a first magnetic yoke 710) provided with the first coil and a second yoke (such as a second magnetic yoke 711) provided with the second coil. The second module (20a) sucks and holds the first module (10) thereon by magnetic attraction produced by the first yoke and the second yoke.

This configuration allows the second module (20a) to support the first module (10) rotatably.

In an actuator (2) according to a sixteenth aspect, which may be implemented in conjunction with any one of the twelfth to fifteenth aspects, the third driving unit is a brushless motor.

This configuration allows the movable range around the third axis to be expanded to 360 degrees or more.

In an actuator (2) according to a seventeenth aspect, which may be implemented in conjunction with the sixteenth aspect, the third coil is constituted of a plurality of drive coils (such as coils 37b). The third magnet is constituted of a plurality of drive magnets (such as magnets 36b). The plurality of drive coils are arranged, in the second module (20a), along a circumference of a circle centered around the third axis. The plurality of drive magnets are provided for the mounting unit (100, 100a) so as to be arranged along a circumference of another circle centered around the third axis and to surround the plurality of drive coils.

This configuration allows the third driving unit to electromagnetically drive the second module (20a) in rotation around the third axis with respect to the mounting unit (100, 100a) with the movable range expanded to 360 degrees or more.

In an actuator (2) according to an eighteenth aspect, which may be implemented in conjunction with the sixteenth aspect, the third coil is constituted of a plurality of drive coils (such as coils 37a). The third magnet is constituted of a plurality of drive magnets (such as magnets 36a). The first module (10) is provided at one of two ends, defined along the third axis, of the second module (20a). The plurality of drive coils are arranged along a circumference of a circle centered around the third axis at the other of the two ends, defined along the third axis, of the second module (20a). The mounting unit (100) includes the plurality of drive magnets and is fitted to the second module (20a) at the other of the two ends thereof defined along the third axis. The plurality of drive magnets are provided for the mounting unit (100) and arranged along a circumference of another circle centered around the third axis so as to surround the plurality of drive coils.

This configuration allows the third driving unit to electromagnetically drive the second module (20a) in rotation around the third axis with respect to the mounting unit (100) with the movable range expanded to 360 degrees or more.

An actuator (2) according to a nineteenth aspect, which may be implemented in conjunction with any one of the twelfth to eighteenth aspects, further includes a rotational driving unit (such as a first rolling driving unit 30c) to electromagnetically drive the first module (10) in rotation around the third axis with respect to the second module (20a).

This configuration allows the actuator (2) to electromagnetically drive the first module (10) in rotation around the third axis with respect to the second module (20a) separately from the third driving unit. For example, the rotational driving unit may rotate the first module (10) around the third axis with respect to the second module (20a) by electromagnetically driving the first module (10) at high frequencies. In addition, the third driving unit may rotate the second module (20a) with respect to the mounting unit (100, 100a) by electromagnetically driving the second module (20a) at low frequencies. As described above, when rotating the first module (10) in the rolling direction with respect to the second module (20a), the known actuator has a movable range of only about 5 degrees. In general, the higher the frequency is, the smaller the amplitude tends to be. That is why high frequencies are suitably used when the movable range is small.

In an actuator (2) according to a twentieth aspect, which may be implemented in conjunction with any one of the twelfth to nineteenth aspects, the second module (20a) is constituted of a third module (20b) and a fourth module (20c). The third module (20b) is configured to be attachable to, and removable from, the fourth module (20c). The third module (20b) and the fourth module (20c) are electrically connected together when the third module (20b) is attached to the fourth module (20c). The third module (20b) is fitted to the first module (10) with a gap left with respect to a first holding mechanism (140) that is rotatable around the first axis and the second axis. The fourth module (20c) is fitted to the mounting unit (100, 100a) via a second holding mechanism (141, 141a) that is rotatable around the third axis. The third module (20b) includes the first coil, the second coil, and a battery (150), and the fourth module (20c) includes the third coil.

This configuration allows, when the third module (20b) is separated from the fourth module (20c), the actuator (2) to be used as a smaller actuator (i.e., an actuator with a stabilizer function). This also allows, when the third module (20b) is attached to the fourth module (20c), the actuator (2) to be used as an actuator to be driven around the third axis and having a movable range of 360 degrees or more.

In an actuator (2) according to a twenty-first aspect, which may be implemented in conjunction with the twentieth aspect, the third module (20b) is configured to be attachable to the fourth module (20c) along either the first axis or the second axis.

This configuration allows the actuator (2) to expand its movable range even when rotating around the first axis or the second axis, depending on how the third module (20b) is attached.

An actuator (2) according to a twenty-second aspect, which may be implemented in conjunction with any one of the twelfth to twenty-first aspects, is used as a camera device (1). This configuration allows the actuator (2) to be used as a camera device (1) with the ability to expand the movable range while simplifying the wiring scheme.

A camera device (1) according to a twenty-third aspect includes the actuator (2) of any one of the twelfth to twenty-first aspects, and a camera module (3) arranged in the first module (10).

This configuration allows the camera device (1) to expand the movable range while simplifying the wiring scheme. For example, the camera device (1) according to the twenty-third aspect may expand the movable range around the third axis.

### REFERENCE SIGNS LIST

1 Camera Device
2 Actuator
3 Camera Module
10 First Module (Movable Unit)
20 Fixed Unit
20a Second Module
20b Third Module
20c Fourth Module
30 Driving Unit
30a Panning Driving Unit
30b Tilting Driving Unit
30c First Rolling Driving Unit (Rotational Driving Unit)
31a Panning Drive Magnet (First Magnet)
31b Tilting Drive Magnet (Second Magnet)
31c First Rolling Drive Magnet
32a Panning Drive Coil (First Coil)
32b Tilting Drive Coil (Second Coil)
32c First Rolling Drive Coil
35 Second Rolling Driving Unit
36 Second Rolling Drive Magnet (Third Magnet)
36a, 36b Magnet (Drive Magnet)
37 Second Rolling Drive Coil (Third Coil)
37a, 37b Coil (Drive Coil)
92 Magnetic Sensor (Detection Unit)
100, 100a Mounting Unit
130 Gyrosensor (Detection Unit)
131 Acceleration Sensor (Sensor Unit)
140 First Holding Mechanism
141, 141a Second Holding Mechanism
150 Battery
710 First Magnetic Yoke (First Yoke)
711 Second Magnetic Yoke (Second Yoke)

1. An actuator comprising:
a first module including a first magnet and a second magnet;
a second module configured to support the first module to make the first module rotatable around each of a first axis and a second axis perpendicular to the first axis; and
a mounting unit including a third magnet and configured to support the second module to make the second module rotatable,
the second module having a movable range of 360 degrees or more with respect to the mounting unit,
the second module including:
a first coil configured to electromagnetically drive the first module in rotation around the first axis with respect to the second module by generating magnetic force between the first coil itself and the first magnet;
a second coil configured to electromagnetically drive the first module in rotation around the second axis with respect to the second module by generating magnetic force between the second coil itself and the second magnet; and
a third coil configured to electromagnetically drive the mounting unit in rotation with respect to the second module by generating magnetic force between the third coil itself and the third magnet.

2. The actuator of claim 1, further comprising a detection unit configured to detect an orientation of the first module, wherein
a rotational drive of the first module around each of the first axis and the second axis is controlled based on a result of detection by the detection unit.

3. The actuator of claim 1, further comprising a sensor unit configured to detect acceleration of the first module or the second module, wherein
the first module is controlled, based on a result obtained by the sensor unit, so as to face a certain direction with respect to gravity.

4. The actuator of claim 1, further comprising:
a first holding mechanism configured to be rotatable around each of the first axis and the second axis and to fit the second module to the first module; and
a second holding mechanism configured to fit the mounting unit to the second module such that the mounting unit is rotatable with respect to the second module, wherein
the second module includes a first yoke provided with the first coil and a second yoke provided with the second coil, and
the second module is configured to suck and hold the first module thereon by magnetic attraction produced by the first yoke and the second yoke.

5. The actuator of claim 1, wherein
the second module is supported by the mounting unit so as to be rotatable around a third axis that is perpendicular to both of the first axis and the second axis.

6. The actuator of claim 5, wherein
the third coil is comprised of a plurality of drive coils,
the third magnet is comprised of a plurality of drive magnets,
the plurality of drive coils are arranged, in the second module, along a circumference of a circle centered around the third axis, and
the plurality of magnets are provided for the mounting unit so as to be arranged along a circumference of another circle centered around the third axis and to surround the plurality of drive coils.

7. The actuator of claim 5, wherein
the third coil is comprised of a plurality of drive coils,
the third magnet is comprised of a plurality of drive magnets,
the first module is provided at one of two ends, defined along the third axis, of the second module,
the plurality of drive coils are arranged along a circumference of a circle centered around the third axis at the other of the two ends, defined along the third axis, of the second module,
the mounting unit includes the plurality of drive magnets and is fitted to the second module at the other of the two ends thereof defined along the third axis, and
the plurality of drive magnets are provided for the mounting unit and arranged along a circumference of another circle centered around the third axis so as to surround the plurality of drive coils.

8. The actuator of claim 1, wherein
the first module is electromagnetically driven in rotation with respect to the second module around a third axis that is perpendicular to both of the first axis and the second axis.

9. The actuator of claim 1, wherein
the second module is comprised of a third module and a fourth module,
the third module is configured to be attachable to, and removable from, the fourth module, the third module and the fourth module being electrically connected together when the third module is attached to the fourth module,
the third module is fitted to the first module via a first holding mechanism that is configured to be rotatable around each of the first axis and the second axis,
the fourth module is fitted to the mounting unit via a second holding mechanism that is configured to be rotatable,
the third module includes the first coil and the second coil, and
the fourth module includes the third coil.

10. The actuator of claim 1, wherein
the actuator is used as a camera device.

11. A camera device comprising:
the actuator of claim 1; and
a camera module arranged in the first module.

12. An actuator comprising:
a first module configured to be rotatable around each of a first axis and a second axis perpendicular to the first axis;
a second module configured to support the first module to make the first module rotatable around each of the first axis and the second axis;
a first driving unit including a first coil and a first magnet and configured to electromagnetically drive the first module in rotation around the first axis with respect to the second module;
a second driving unit including a second coil and a second magnet and configured to electromagnetically drive the first module in rotation around the second axis with respect to the second module;
a mounting unit to be fitted to the second module; and
a third driving unit including a third coil and a third magnet and configured to electromagnetically drive the second module in rotation around a third axis, which is perpendicular to both of the first axis and the second axis, with respect to the mounting unit with a moving range expanded to 360 degrees or more,
the first coil, the second coil, and the third coil being provided for the second module.

13. The actuator of claim 12, further comprising a detection unit configured to detect an orientation of the first module, wherein
the first driving unit, the second driving unit, and the third driving unit are configured to control rotation based on a result of detection by the detection unit.

14. The actuator of claim 12, further comprising a sensor unit configured to detect acceleration of the first module or the second module, wherein
the first driving unit, the second driving unit, and the third driving unit control, based on a result obtained by the sensor unit, the first module such that the first module faces a certain direction with respect to gravity.

15. The actuator of claim 12, further comprising:
a first holding mechanism configured to be rotatable around each of the first axis and the second axis and to fit the second module to the first module with a gap left between the first module and the second module; and
a second holding mechanism configured to be rotatable around the third axis and to fit the mounting unit to the second module, wherein
the second module includes a first yoke provided with the first coil and a second yoke provided with the second coil, and
the second module is configured to suck and hold the first module thereon by magnetic attraction produced by the first yoke and the second yoke.

16. The actuator of claim 12, wherein
the third driving unit is a brushless motor.

17. The actuator of claim 16, wherein
the third coil is comprised of a plurality of drive coils,
the third magnet is comprised of a plurality of drive magnets,
the plurality of drive magnets are arranged, in the second module, along a circumference of a circle centered around the third axis, and
the plurality of drive magnets are provided for the mounting unit so as to be arranged along a circumference of another circle centered around the third axis and to surround the plurality of drive coils.

18. The actuator of claim 16, wherein
the third coil is comprised of a plurality of drive coils,
the third magnet is comprised of a plurality of drive magnets,
the first module is provided at one of two ends, defined along the third axis, of the second module,
the plurality of drive coils are arranged along a circumference of a circle centered around the third axis at the other of the two ends, defined along the third axis, of the second module,
the mounting unit includes the plurality of drive magnets and is fitted to the second module at the other of the two ends thereof defined along the third axis, and
the plurality of drive magnets are provided for the mounting unit and arranged along a circumference of another circle centered around the third axis so as to surround the plurality of drive coils.

19. The actuator of claim 12, further comprising a rotational driving unit configured to electromagnetically drive the first module in rotation around the third axis with respect to the second module.

20. The actuator of claim 12, wherein
the second module is comprised of a third module and a fourth module,
the third module is configured to be attachable to, and removable from, the fourth module, the third module and the fourth module being electrically connected together when the third module is attached to the fourth module,
the third module is fitted to the first module with a gap left with respect to a first holding mechanism that is configured to be rotatable around each of the first axis and the second axis,
the fourth module is fitted to the mounting unit via a second holding mechanism that is configured to be rotatable around the third axis,
the third module includes the first coil, the second coil, and a battery, and
the fourth module includes the third coil.
